(19) United States
(12) Patent Application Publication
(10) Pub. No.: US 2011/0041052 A1
(43) Pub. Date: Feb. 17, 2011

(54) Markup language-based authoring and runtime environment for interactive content platform

(75) Inventor: Daniel J. Fraisl, Saratoga, CA (US)

Correspondence Address: LAW OFFICE OF DAVID H. JUDSON, 15950 DALLAS PARKWAY, SUITE 225, DALLAS, TX, 75248, US

(73) Assignee: ZOOMII, INC., Saratoga, CA (US)

(21) Appl. No.: 12/836,332

(22) Filed: Jul. 14, 2010

Related U.S. Application Data
(60) Provisional application No. 61/225,389, filed on Jul. 14, 2009.

(51) Int. Cl. G06F 17/00

(52) U.S. Cl. 715/234

(57) ABSTRACT

A machine-implemented method for building, publishing and executing interactive content applications using an XML-based language is described. In one embodiment, static content is processed or annotated to generate XML that conforms to an Interaction Markup Language (IML). IML is an XML-based language designed to represent, store, and render user interaction semantics for any printed or computer displayed content. IML is cross-platform, portable, and human readable. The IML language enables a programmer to define rich user interactions (called Interaction Objects) that include, for example, automatic user input assessment and evaluation, user feedback, hinting, adaptive behavior, and looping. IML provides for the definition of both Interaction Objects that are bound to regions on a page or computer display. Preferably, the syntax and semantics of IML allows the “meaning” of an interaction to be defined and interpreted by any runtime engine that executes IML. IML facilitates interactivity with IML content pages that are authored to be executed in any IML-based runtime environment. IML is used to create interactive applications for workbook content, study guides, learning assistant card, assessment tests, learning games, open content, interactive content, and the like.

This application is based on and claims priority to Ser. No. 61/225,389, filed Jul. 14, 2009.

This application includes subject matter protected by copyright. All rights are reserved.

### BACKGROUND OF THE INVENTION

1. Technical Field

This disclosure relates generally to interactive technologies.

2. Background of the Related Art

It is known in the prior art to provide a paper-based computing platform using “smartpen” technologies. One such commercial system is provided by Livescribe and comprises a suite of complementary products and technologies: the Pulse™ smartpen, which is a pen-based computer for handwriting capture and audio recording, Livescribe Dot paper, a technology that enables interactive, “live” documents using plain paper printed with micro-dots, associated software applications and tools that provide audio/ink capture, and handwriting recognition, and a set of development tools to enable consumers and developers to create, publish and share new applications and content online.

The Livescribe Smartpen application associates a user's smartpen actions, such as writing, tapping, and audio recording, to the dot paper. A typical application comprises a “paper product,” which consists of the physical dot paper a user interacts with together with an electronic file representation thereof, and one or more associated (linked) so-called “penlets,” which are Java applications developed to interact with specific active regions defined on the paper product. The active regions can be static or dynamic. The electronic file representation of a paper product is a container file that describes the paper product to the penlets. The container file is installed on the smart pen together with the penlets that use them. This enables the smart pen to recognize and use the paper product, in particular, by having a penlet respond to events in the active regions and, in response, to perform given actions.

Further details regarding the Livescribe system and technologies can be found in U.S. Publication No. 20090024988, among others.

### BRIEF SUMMARY OF THE INVENTION

A machine-implemented method for building, publishing and executing interactive content applications using an XML-based language is described. In one embodiment, static content is processed or annotated to generate XML that conforms to an Interaction Markup Language (IML). IML is an XML-based language designed to represent, store, and render user interaction semantics for any printed or computer displayed content. IML is cross-platform, portable, and human readable. The IML language enables a programmer to define rich user interactions (called interaction objects) that include, for example, automatic user input assessment and evaluation, user feedback, hinting, adaptive behavior, and looping. An interaction object defines the semantics of a user interaction and is specified with the IML language. A programmer can create an interaction object via collections of IML tags. The IML tags then represent the meaning and intended outcome of a user interacting with content. IML provides for the definition of interaction objects that are bound to regions on a page or computer display. Preferably, the syntax and semantics of IML allows the “meaning” of an interaction to be defined and interpreted by any runtime engine that is designed to execute IML. An IML runtime environment is then used to interpret the interaction objects specified by the IML.

In a representative embodiment, IML is generated and used to create an IML content page for interactive content (e.g., a student workbook) that is designed to be used in association with a smartpen. The smartpen includes or has associated therewith the IML runtime environment (e.g., an IML interpreter) for the IML content page. As a result of the authoring, the IML provides markup language-based tags for asking the user a question, automatically grading the response, optionally giving the user feedback about their response, and storing their response for later analysis. One or more responses to an IML interaction can be automatically stored and sent to a server (with an associated database) for analysis and/or reporting. Because IML formally defines a means to evaluate a user response and send (to a server or other target resource, such as a database) that response in a well-defined format, an application written in IML also can dynamically adapt to individual users by automatically downloading new IML fragments based on previous user input.

IML is extensible so that a programmer can define new IML tags that add behavior to the IML language. In a representative embodiment, IML is used to create interactive applications for workbook content, study guides, learning assistant card, assessment tests, learning games, open content, interactive content, and the like.

The foregoing has outlined some of the more pertinent features of the invention. These features should be construed to be merely illustrative. Many other beneficial results can be attained by applying the disclosed invention in a different manner or by modifying the invention as will be described.

### BRIEF DESCRIPTION OF THE DRAWINGS

For a more complete understanding of the present invention and the advantages thereof, reference is now made to the following descriptions taken in conjunction with the accompanying drawings, in which:

FIG. 1 depicts an exemplary block diagram of an authoring and runtime environment in which exemplary aspects of the illustrative embodiments may be implemented;

FIG. 2 depicts a representative user interface (UI) for an IML authoring tool for use in converting a static page to an IML content page that includes one or more interaction objects;

FIG. 3 is an exemplary block diagram of an authorizing, publishing and interaction environment in which exemplary aspects of the illustrative embodiments may be implemented;

FIG. 4 illustrates a back-end web services environment for use with the IML framework;

FIG. 5 illustrates representative interactive content that is created using the techniques of this disclosure.

### DETAILED DESCRIPTION OF AN ILLUSTRATIVE EMBODIMENT

The subject matter of this application relates generally to a suite of tools to facilitate interactivity (e.g., such as adaptive learning) with content, preferably using pen-based tools (e.g., such as the Livescribe® Pulse™ smartpen) or other runtime environments. The techniques described herein may also be implemented with other Internet-accessible mobile computing devices, such as the Apple iPhone®, iPad™, iPod touch™, the Amazon Kindle®, other eBook readers, other mobile computers, and the like. For convenience of illustration only, the platform technologies are described for use with a smartpen application.

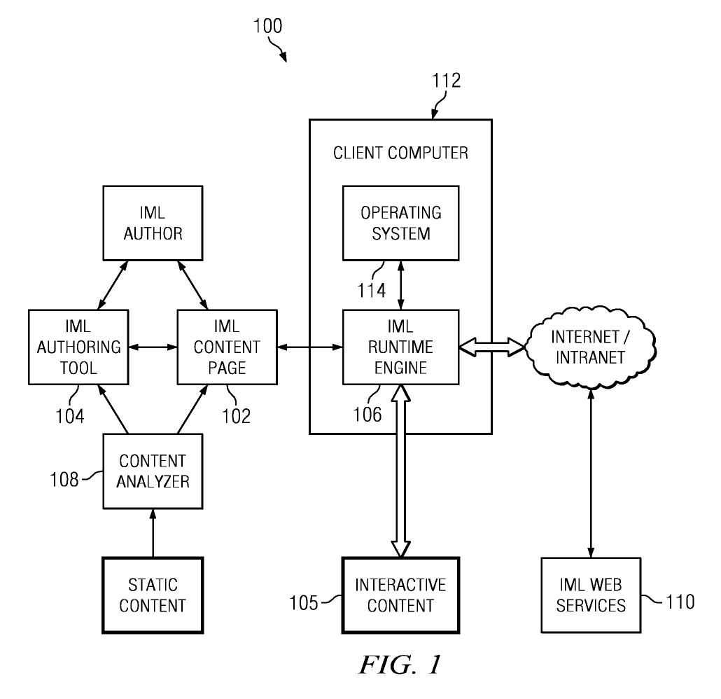

An authoring and runtime platform 100 is illustrated in FIG. 1, and it comprises a set of enabling technologies, applications, devices and systems. The components shown in the drawing typically are computing entities, such as data processing systems each comprising hardware and software, which entities communicate with one another over a network, such as the publicly-routed Internet, an intranet, an extranet, a private network, or any other communications medium or link. As described below, a data processing system typically comprises one or more processors, an operating system, an application server, one or more applications and one or more utilities. Preferably, the techniques described herein use an eXtensible Markup Language (XML), which is referred to as the Interaction Markup Language (IML), for building interactive applications that run on a smartpen or other runtime environment. Familiarity with XML techniques is presumed, and a representative IML sample is shown below. Extensible markup language (XML) facilitates the exchange of information in a tree structure. An XML document typically contains a single root element. Each element has a name, a set of attributes, and a value consisting of character data, and a set of child elements. The interpretation of the information conveyed in an element is derived by evaluating its name, attributes, value and position in the document. Simple Object Access Protocol (SOAP) is a lightweight XML based protocol commonly used for invoking Web Services and exchanging structured data and type information on the Web. Using SOAP, XML-based messages are exchanged over a computer network, normally using HTTP (Hypertext Transfer Protocol).

According to this disclosure, Interaction Markup Language is an XML-based language designed to represent, store, and render user interaction semantics for any printed or computer displayed (or output) content. IML is cross-platform, portable, and human readable. The IML language enables a programmer to define rich user interactions (called interaction objects) that include, for example, automatic user input assessment and evaluation, user feedback, hinting, adaptive behavior, and looping. IML provides for the definition of both interaction objects that are bound to regions on a page or computer display. Preferably, the syntax and semantics of IML allows the “meaning” of an interaction to be defined and interpreted by any runtime engine that is designed to execute IML. Rather than define input controls such as simple “text” fields (such as might done in other languages such as HTML), IML allows for the creation of interaction objects like “multiple choice question” that may include additional attributes such as hints for the purpose of helping the user learn a particular concept associated with the question. Because of this, IML enables developers to build new smartpen or other applications at a higher-level than previously possible. IML-based applications are easier and faster to build and more reliable because the language allows the programmer to think in terms of “user interactions” rather than low level computer code.

For example, IML provides markup language-based tags for asking the user a question, automatically grading the response, optionally giving the user feedback about their response, and storing their response for later analysis. This type of user interaction would traditionally need to be custom programmed in a low-level computer language like Java or C. All user responses to an IML interaction can be automatically stored and sent to a server (with an associated database) for analysis and/or reporting. Because IML formally defines a means to evaluate a user response and send (to a server or other target resource, such as a database) that response in a well-defined format, an application written in IML also can dynamically adapt to individual users by automatically downloading new IML fragments based on previous user input. Using this mechanism, the application (in effect) behaves differently for different users of the application, as particular user responses may generate queries to different data sources. Thus, a first user's interaction with the IML content page may differ from a second user's interaction with that same page. Preferably, IML is extensible so the programmer can define new IML tags that add behavior to the IML language. In a representative embodiment, IML can be used to create interactive applications for: workbook content, study guides, learning assistant card, assessment tests, learning games, open content, interactive content, and the like. These examples are not meant to be limiting.

Generalizing, the platform 100 is used to generate one or more IML content pages 102. An IML content page typically is a collection of valid IML tags representing one or more interaction objects. IML content pages are created in any common text editor by a programmer or, alternatively, in an IML authoring tool 104 with design, editing and publishing controls for automatically generating valid IML interaction objects and statements. The IML authoring tool 104 thus is used to create interactive content 105 (typically IML content pages and associated static content) that can be loaded on a computing device 112 capable of running an IML runtime engine 106. The IML runtime engine may be implemented as an interpreter that reads and understands IML tags and performs one or more actions that embody the semantics of a user interaction defined by the IML. Preferably, the authoring tool 104 provides an extensible user interface (UI) for creating interaction objects and editing their properties. As new interaction objects (and corresponding IML tags) are defined, they appear in an interaction object pallet. The IML authoring tool reads and writes IML. Because the IML authoring tool creates IML content pages 102 that are independent and distinct from any computer application software code, the IML content pages can be moved from machine to machine and executed on any computing device capable of hosting (running) an IML runtime engine 106.

An interaction object can contain another interaction object. There may be a hierarchy of interaction objects.

Using the authoring tool, the author thus can add interactivity at any level of a given piece of content. Thus, for example, with respect to a particular source document that includes text, interactivity controls may be identified and positioned at any level, including phoneme, word, phrase, sentence, paragraph, and the like. When the resulting application is executed in a runtime pen-based environment, for example, conventional “listen-record-compare” functionality (standard instructional practice) can be implemented at any such level. In this way, the inventive framework can be used to re-purpose and/or to extend existing content.

As also seen in FIG. 1, the platform 100 may also include an IML content analyzer 108. The IML content analyzer 108 parses static content of various types. Input types could include text documents, web pages, images, .pdf-format files or other computer readable formats. As the content analyzer 108 parses through content, it identifies patterns or other indicia or attributes that can be used to automatically generate IML content pages 102 which, in turn, transform (or convert) static content into interactive content with all the inherent behaviors defined by the available IML tags. For example, with a static text document, the IML content analyzer 108 identifies words, sentences, phrases, paragraphs, and/or pages, then writes IML objects to an IML content page 102. When the automatically-generated IML content page then is executed by the IML runtime engine 106, the original static text document becomes interactive. Thus, where interactivity has been added to a word, a user can touch the word, for example (e.g., with the smartpen device), and that word could be spoken or its definition looked up in a dictionary. The content analyzer 108 can be used as part of an IML authoring tool 104, or it can be executed in a separate (e.g., a server) environment where static documents can be converted to interactive documents programmatically or otherwise with no human intervention.

As noted above, the client IML runtime engine 106 interprets and executes the IML language. The runtime engine also provides standard interfaces for storing IML data and exchanging IML data with an IML web service 110 running on the Internet. Typically, the IML runtime engine is a program written in a traditional computer language that runs on a client smartpen device or any other computer 112 and operating system 114 designed to execute end user applications (e.g., the iPhone, the Kindle, or the like). Preferably, the IML runtime engine provides a common runtime environment for IML-based applications, an interpreter that executes the IML, and a common data store and web service interface for exchanging data with IML web services. The IML runtime engine resides on any device that supports IML. The IML runtime engine can be extended by simply adding new IML tags and an implementation for each tag. In a representative smartpen embodiment, the IML runtime engine is invoked when a user interacts with any dot-enabled paper product, such as the Livescribe technologies described above.

During an authoring process, the IML programmer or the authoring tool 104 binds various IML interaction objects to areas on a page (or portion thereof), preferably using a drop-and-drag tool to identify and place predefined IML objects on a page. Later, when an area on a page is tapped or drawn on (e.g., by a smartpen), the IML runtime engine 106 automatically loads the particular IML content page 102 associated with that area into computer memory and executes the IML. The result is that the user can interact with the page; and the page will have behaviors defined by the corresponding IML. The result of each user interaction with the page preferably is recorded by the IML runtime engine (e.g., in both computer memory and perhaps permanent storage) as a new fragment of IML for that particular response. Multiple responses are collected by the IML runtime engine, preferably all as new fragments of IML, and then sent to an IML web service 110 for processing, analysis, and storage.

IML web service 110 provides reporting, analysis, and adaptive feedback for IML-based content pages. In particular, and as noted above, the IML web service 110 collects user responses from IML-based applications and optionally automatically generates and downloads new IML applications based on those user responses. Because IML-based interactive content can communicate in a standard format (e.g., SOAP-based HTTP) with IML web services, IML-based applications can adapt in real-time based on user input. For example, a student might answer several related questions incorrectly. As these IML responses are sent to an IML web service, new fragments of IML or entire IML content pages can be generated on-the-fly and returned to the user with further questions or hints relating to the topics where the student needs more practice. Similarly, if the student answers all questions correctly, new IML content pages can be generated and returned to the user with more advanced interactive learning content.

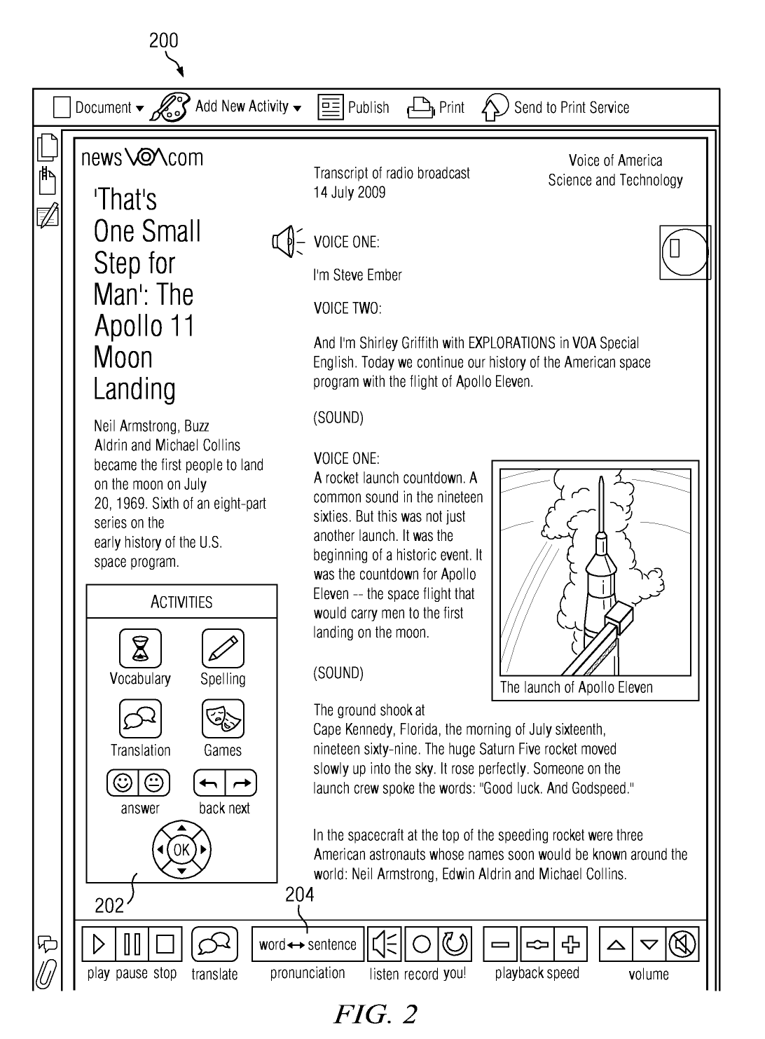

FIG. 2 is a representative user interface (UI) 200 for the IML authoring tool. The tool includes an authoring palette (or, more generally, a display panel) on which a page of static content is displayed. Each section of the page (e.g., headings, text, images, embedded videos, or the like) may be processed (e.g. using conventional drop-and-drag tools) to create an interaction object associated with the page content. The scope and type of interactivity may be quite varied. In this example, there may be a vocabulary interaction object, a spelling interaction object, a translation interaction object, a game interaction object, an answer interaction object, and so forth. In this embodiment, the individual interaction objects are selected from the Activities panel 202, which is a palette of interaction objects palette 202. Other techniques (such as display tabs, pull-down menus, etc.) may be used for authoring. When an interaction object is applied to (or, more generally, associated with) a particular piece of content, the IML authoring tool creates IML. For example, in FIG. 2, an existing ‘pronunciation’ graphic 204 has been augmented with an interaction object that was overlaid by the programmer (e.g., via a drop-and-drag or similar operation) and, as a result, represents a complete speech pronunciation practice activity intended to allow a user to engage in speech practice via any word or sentence on the content page. In this case, the words and sentences have been automatically identified by a content analyzer (such as element 108 in FIG. 1) and converted to an interaction object as well. The authoring tool then generates IML statements for both the pronunciation practice interaction and for all other content page interaction objects that may be associated therewith.

One approach to creating IML is to augment the page's existing source. Thus, for example, if the page is written in HTML (as in a web page), IML is written into the page source directly to create the IML-based content page. Of course, the particular technique for generating the IML content page will depend on the source encoding of the original static content. Of course, it is not necessary that an IML content page be derived from a static content page, and the IML content page may be generated in the first instance using an authoring tool or editor.

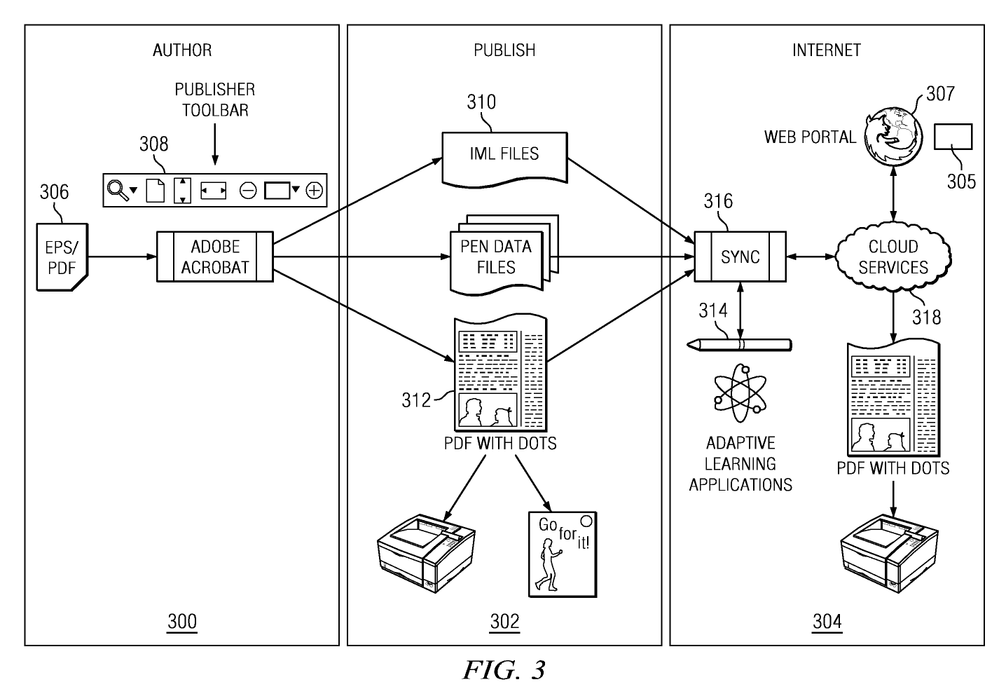

Referring now to FIG. 3, an end-to-end IML environment typically has (3) stages, namely, authoring 300, publishing 302, and interaction 304. These stages may be implemented at different times, at different places, and using different systems and entities. Thus, for example, an author/developer may perform authoring 300, while a publisher performs publishing 302, while an end user performs interaction 304. As noted above, interactions typically involve the analysis, reporting and storage of IML-generated interactivity data, the creation of new or modified IML content pages, and the like. To this end, a service provider 305 (distinct from any of the other described entities) may operate a web portal 307 to facilitate one or more of the authoring, publishing and/or interaction activities. One of the author, publish or interaction entities may operate the web portal. In one embodiment, the IML authoring tool runs as a plug-in to some other client-side application, such as Adobe Acrobat®, Microsoft Word®, or the like. An end user takes static content, such as a PDF document 306, and executes the authoring tool, e.g. by selecting a publisher toolbar 308. The resulting IML content page 310 comprises a set of one or more IML files that are published during the publishing stage 302. In this example, the PDF document has also been processed (by other means external to this disclosure) to create a dot-based document 312 readable by a smartpen device 314. In the framework that is shown in FIG. 3, the authoring/publishing steps are used to create an adaptive learning application that runs on the smartpen (or other such processor-based, Internet-accessible mobile devices) to connect users (e.g., students) to content (e.g., interactive workbooks) and adaptive learning engines that may execute over the Internet. During the interaction, a synchronization process 316 collects and synchronizes the content, assessment data (that may be generated during the interaction) and other control data, facilitates local storage of that data, and interacts as necessary a cloud-based service 318.

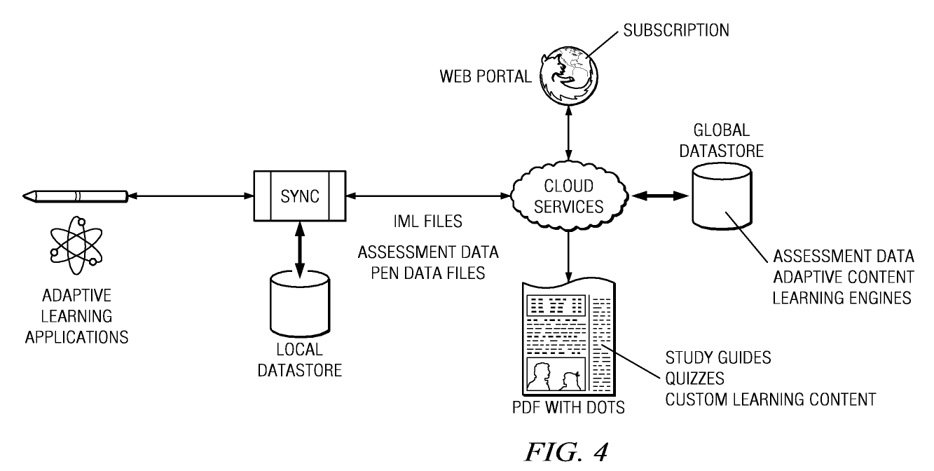

FIG. 4 illustrates one or more cloud services that may be associated with the IML environment or framework. Generally, these services track learning progress and generate customized learning content based on, for example, real-time assessment data.

Thus, in a representative implementation, the pen- or device-based components of the system comprise a runtime engine, which is a generic player for IML-based interactive content. The runtime engine provides a common environment for all IML-based content and an interpreter that executes IML. IML enables learning interaction semantics to be expressed in an XML-based static representation. It combines interaction definitions and user response to enable the convenient definition of learning activity regions (interaction objects) on a page together with basic interactive controls. IML, as noted above, also preferably defines how interaction objects use the underlying dot paper.

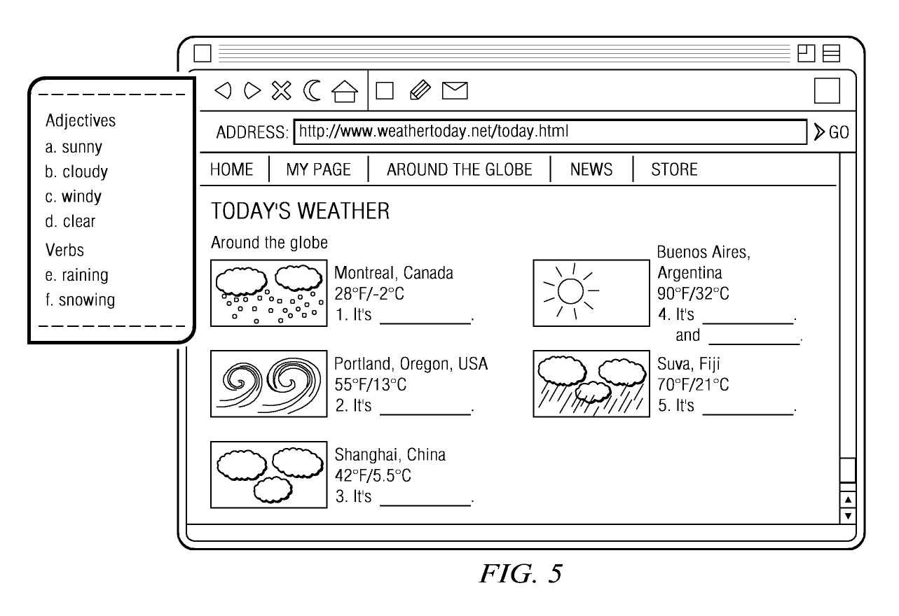

A sample IML content page (an IML application) is now described. This page has been authored with one or more interaction objects and then published. FIG. 5 illustrates the display page from the end user's perspective. The page is displayed as a web page within a conventional web browser, although this is merely for illustrative purposes, as the content page may be displayed (or more generally output) in any client-side application. In this example, the page illustrates a weather report for a number of cities around the world. The user is being asked to match a word (an adjective) in the displayed box with a city. The underlying IML is now described.

A first portion of the markup simply defines the document (or document portion) using a set of <document> tags, as in the following example (© Zoomii, Inc., all rights reserved):

```
<document>
    <owner>Company Inc.</owner>
    <series>Worldlink</series>
    <book>Workbook</book>
    <chapter>Unit 2</chapter>
    <page>14</page>
    <description>Zoomii interactive workbook page</description>
    <author>B. Klein</author>
    <category>optional</category>
    <comments>optional</comments>
    <link>optional</link>
</document>
```

A next portion of the markup defines a collection of tasks (in this case, a “Vocabulary Link”) involved and the amount of points associated with a correct answer. A pair of <content> tags is used to delineate this portion of the markup:

```
<content>
    <section name=“Lesson 1” zid=“1” area_id=“10”>
        <description>VocabularyLink</description>
        <text>1. Vocabulary Link</text>
        <section name=“1A” zid=“2” area_id=“11”>
            <description>Section A marker</description>
            <text>A. Pair work</text>
            <value units=‘points’>5</value>
<instructions>
    <text>Write the letter or name in the blank.</text>
</instructions>
```

The <content></content> tag elements include a representative <control> interaction object, in this example, a fill-in-the-blank control that identifies the possible answers and tracks the correct and incorrect responses:

```
<controls>
  <fillintheblank_control>
    <correctresponse>
      <audio group=“correctornot” track=“1”/>
      <text>Yes! - correct</text>
    </correctresponse>
    <incorrectresponse>
      <audio group=“correctornot” track=“2”/>
      <text>No - incorrect</text>
    </incorrectresponse>
      <answers unique=“yes”>
      <count>6</count>
      <answer id=“1”>
        <text>a</text>
        <text>sunny</text>
      </answer>
      <answer id=“2”>
        <text>b</text>
        <text>cloudy</text>
      </answer>
      <answer id=“3”>
        <text>c</text>
        <text>windy</text>
      </answer>
      <answer id=“4”>
        <text>d</text>
        <text>clear</text>
      </answer>
      <answer id=“5”>
        <text>e</text>
        <text>raining</text>
      </answer>
      <answer id=“6”>
        <text>f</text>
        <text>snowing</text>
      </answer>
    </answers>
```

The control interaction object also identifies the specific questions:

```
<question zid=“3” area_id=“12”>
    <description>Montreal, Canada</description>
    <text>1. Montreal, Canada</text>
    <correctresponse>6</correctresponse>
    <value units=‘points’>1</value>
</question>
<question zid=“4” area_id=“13”>
    <description>Portland, Oregon</description>
    <text>2. Portland, Oregon</text>
    <correctresponse>3</correctresponse>
    <value units=‘points’>1</value>
</question>
<question zid=“5” area_id=“14”>
    <description>3. Shanghai, China</description>
    <text>Shanghai, China</text>
    <correctresponse>2</correctresponse>
    <value units=‘points’>1</value>
</question>
<question zid=“6” area_id=“15”>
    <description>4.a Buenos, Aires</description>
    <text>Buenos, Aires, part a.</text>
    <correctresponse>4</correctresponse>
    <correctresponse>1</correctresponse>
    <value units=‘points’>2</value>
</question>
<question zid=“7” area_id=“16”>
    <description>5. Suva, Fiji</description>
    <text>Suva, Fiji</text>
    <correctresponse>5</correctresponse>
    <value units=‘points’>1</value>
</question>
                </fillintheblank_control>
            </controls>
        </section>
    </section>
</content>
```

A final section of the IML identifies a set of audio resources that the author/developer has defined for the project.

```
    <resources>
        <audiogroup name=“correctornot”>
            <track id=“1” rid=“f779” />
            <track id=“2” rid=“f779” />
        </audiogroup>
    </resources>
</iml>
```

The smartpen technologies have been described and may be implemented using commercial products and systems such as Livescribe Pulse. Such smartpen technologies are not limited to such products and systems.

There are many ways in which the authoring, publishing and interactive services may be implemented, and the disclosed subject matter is not limited to any particular one. For purposes of illustration, the subject matter herein is shown as being implemented in a distributed computer environment. The inventive framework may be implemented as a product or a service, or some combination thereof. A representative system in which the subject matter is implemented comprises any set of one or more computing resources including machines, processes, programs, functions, data structures, and the like. Of course, any other hardware, software, systems, devices and the like may be used. More generally, the subject matter may be implemented with any collection of autonomous or other computers (together with their associated software, systems, protocols and techniques) linked by a network or networks.

As previously noted, the hardware and software systems in which the invention is illustrated are merely representative. The invention may be practiced, typically in software, on one or more machines. Generalizing, a machine typically comprises commodity hardware and software, storage (e.g., disks, disk arrays, and the like) and memory (RAM, ROM, and the like). The particular machines used in the system are not a limitation of the present invention. A given machine includes network interfaces and software to connect the machine to a network in the usual manner. The cloud services may be implemented as a managed service (e.g., in a hosted model) using a set of machines, which are connected or connectable to one or more networks. More generally, the product or service is provided using a set of one or more computing-related entities (systems, machines, processes, programs, libraries, functions, or the like) that together facilitate or provide the inventive functionality described above. In a typical implementation, the service comprises a set of one or more computers. A representative machine is a network-based server running commodity (e.g. Pentium-class) hardware, an operating system (e.g., Linux, Windows, OS-X, or the like), an application runtime environment (e.g., Java, .ASP), and a set of applications or processes (e.g., AJAX technologies, Java applets or servlets, linkable libraries, native code, or the like, depending on platform), that provide the functionality of a given system or subsystem. As described, the product or service may be implemented in a standalone server, or across a distributed set of machines. Typically, a server connects to the publicly-routable Internet, a corporate intranet, a private network, or any combination thereof, depending on the desired implementation environment.

While the above describes a particular order of operations performed by certain embodiments of the invention, it should be understood that such order is exemplary, as alternative embodiments may perform the operations in a different order, combine certain operations, overlap certain operations, or the like. References in the specification to a given embodiment indicate that the embodiment described may include a particular feature, structure, or characteristic, but every embodiment may not necessarily include the particular feature, structure, or characteristic.

While given components of the system have been described separately, one of ordinary skill will appreciate that some of the functions may be combined or shared in given instructions, program sequences, code portions, and the like.

Having described our invention, what is claimed follows below.

What is claimed is:

1. A method to facilitate a learning activity, comprising:
receiving a markup language document that comprises a set of markup language tags that define at least one interaction object, the interaction object defining semantics of a user interaction with respect to a piece of content associated with the markup language document; and
executing the interaction object specified by the markup language tags as a user interacts with the piece of content to facilitate the learning activity.

2. The method as described in claim 1 wherein the markup language tags represent a meaning and an intended outcome of the user's interaction with the piece of content.

3. The method as described in claim 1 wherein the interaction object is bound to the piece of content.

4. The method as described in claim 1 wherein the interaction object is executed by a runtime interpreter.

5. The method as described in claim 4 wherein the runtime interpreter is executed in a smartpen.

6. The method as described in claim 1 further including one or more additional interaction objects.

7. The method as described in claim 6 wherein a first interaction object is nested within a second interaction object.

8. The method as described in claim 1 wherein the markup language page is authored in an off-line process.

9. The method as described in claim 1 wherein the user interaction comprises one of: user input assessment and evaluation, user feedback, hinting, adaptive behavior, and looping.

10. The method as described in claim 1 wherein the markup language page is XML-based.

11. The method as described in claim 1 wherein the piece of content, in its original form, is print-based and non-interactive.

12. The method as described in claim 1 wherein the markup language document conforms to a markup language.

13. The method as described in claim 12 wherein the markup language is extensible to include a tag that defines a given user interaction semantic.

14. Apparatus, comprising:
a processor,
computer memory holding computer program instructions that when executed comprise a method of authoring an interactive application for execution in a runtime environment to facilitate a user interaction, the method comprising:
associating a predefined interaction object with a piece of content using an authoring tool, the interaction object defining semantics of a user interaction with respect to the piece of content; and
generating, using the authoring tool, a markup language page that binds the predefined interaction object with the piece of content to facilitate a learning activity.

15. The apparatus as described in claim 14 wherein the markup language page conforms to an extensible markup language that defines a set of intended meanings associated with anticipated user interactions and outcomes with the piece of content.
